(19) United States
(12) Patent Application Publication
(10) Pub. No.: US 2011/0154191 A1
(43) Pub. Date: Jun. 23, 2011

(54) METHODS, APPARATUS AND ARTICLES OF MANUFACTURE TO PRESENT CHANGES IN CLINICAL RECORDS

(76) Inventors: Biby Kuriakose, Bangalore (IN); Donna Maddox, Ballwin, MO (US); Harsha Nandi, Bangalore (IN); Abhilash Kolanthara, Bangalore (IN)

(21) Appl. No.: 12/644,227

(22) Filed: Dec. 22, 2009

(51) Int. Cl. G06F 3/048; G06F 17/30; G06F 17/00

(52) U.S. Cl. 715/256; 715/821; 707/769; 715/764; 707/E17.014

(57) ABSTRACT

Example methods, apparatus and articles of manufacture to present changes in clinical records are disclosed. A disclosed example method includes identifying a difference between first and second clinical records of a patient, forming an animated clinical record display including the first clinical record and an animated depiction of the identified difference, and presenting the animated clinical record display at an output device.

### FIELD OF THE DISCLOSURE

This disclosure relates generally to clinical records and, more particularly, to methods, apparatus and articles of manufacture to present changes in clinical records.

### BACKGROUND

Healthcare environments, such as hospitals, doctor offices or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include, for example, patient medical histories, examination notes, laboratory results, imaging data, diagnostic test results, diagnosis information, management information, insurance information, and/or scheduling information. The information may be centrally stored or divided at a plurality of locations. Healthcare practitioners may desire to access patient information or other information at various points in a healthcare workflow. For example, during and/or after surgery, medical personnel may access patient information, such as images of a patient's anatomy, that are stored in a medical information system. Radiologist and/or other clinicians may review stored images and/or other information, for example.

### BRIEF DESCRIPTION OF THE INVENTION

In view of the following descriptions and figures, it should be clear that the present disclosure describes methods, apparatus and articles of manufacture to present changes in clinical records. While current systems for reviewing and/or accessing clinical or medical records provide all available medical information on a screen for a user, such information may not be organized in a way to readily facilitate medical evaluation, diagnosis and/or treatment. Further, there are currently no ways to tell the user whether these data elements are important. Further still, there are currently no ways to automatically identify and/or visualize the changes that have occurred in a patient's clinical records overtime. Current methods of simply browsing through passively presented lists and/or tables of clinical records and/or clinical record entries may be problematic as it may represent a huge disruption in a physician's workflow and/or may fail to yield the desired information. Moreover, such passively presented tables and/or lists do not convey how clinical records have changed, who changed them, etc.

The example methods, apparatus and articles of manufacture disclosed herein provide certain advantages over existing clinical record presentations. In stark contrast to the passive presentation of a list and/or table of clinical records and/or clinical record entries, the example methods, apparatus and articles of manufacture disclosed herein automatically and/or actively identify the differences between two or more clinical or medical records and display such identified differences using visual enhancements and/or visual emphases that quickly draws a user's attention to what in the patient's clinical or medical records have changed. For example, text that is present in a first clinical entry and/or record and is absent in a subsequent entry and/or record may be highlighted in red and/or displayed using striking through (e.g., striking through) of the text. Likewise, text that was not present in the first entry and/or record and is present in a previous entry and/or record may be highlighted in green and/or underlined. It should be appreciated that the automatic highlighting and emphasis of changed contents of entries and/or records can quickly identify for a user changes that may be of importance. In some examples, the highlighting, striking through and/or underlining may be presented in an animated clinical record display to further assist the user in identifying and/or visualizing the order and/or sequence of clinical record changes. Such automated visualizations of clinical record changes may be especially useful in workflows involving multiple care teams (e.g., nurse shifts) and/or multiple medical professionals by enabling a medical professional to quickly identify what has changed during and/or from previous time intervals without have to manually examine multiple clinical records.

According to certain aspects of this disclosure, an example method includes identifying a difference between first and second clinical records of a patient, forming an animated clinical record display including the first clinical record and an animated depiction of the identified difference, and presenting the animated clinical record display at an output device.

According to further aspects of this disclosure, an example apparatus includes a differencer to identify a difference between first and second clinical records, the first and second clinical records associated with a same patient, an animator to form clinical record display including the first clinical record and an animated emphasized representation of the identified difference, and an output device to present the animated clinical record display.

According to still further aspects of this disclosure, an example article of manufacture stores machine-readable instructions that, when executed, cause a machine to identify a difference between first and second clinical records of a patient, present the first clinical record at an output device, and modify the presented first clinical record to emphasize the identified difference.

According to additional aspects of this disclosure, another example method includes identifying a difference between first and second clinical records of a patient, forming a clinical record display including the first clinical record and a depiction of the identified difference, and presenting the clinical record display at an output device.

### BRIEF DESCRIPTION OF THE DRAWINGS

FIG. 1 is a schematic illustration of an example clinical records system within which the example methods, apparatus and articles of manufacture described herein may be implemented.

FIG. 2 illustrates an example manner of implementing the example clinical history presenter of FIG. 1.

FIG. 3 is a flowchart representative of an example process that may be carried out by, for example, a processor to implement the example clinical history presenter of FIGS. 1 and 2.

FIGS. 4A-C and 5A-F illustrate example clinical record displays that may be presented by the example clinical history presenter and/or, more generally, the example clinical record server of FIGS. 1 and 2.

FIG. 6 illustrates a snapshot of an example clinical record display that may be presented by the example clinical history presenter and/or, more generally, the example clinical record server of FIGS. 1 and 2.

FIG. 7 is a schematic illustration of an example processor platform that may be used and/or programmed to carry out the example process of FIG. 3 and/or to implement any or all of the example methods, apparatus and articles of manufacture described herein.

### DETAILED DESCRIPTION

In the interest of brevity and clarity, throughout the following disclosure references will be made to an example clinical records server 100. However, the methods, apparatus and articles of manufacture described herein to present changes in clinical records may be implemented by and/or within any number and/or type(s) of additional and/or alternative clinical records systems, servers and/or client devices. Such additional and/or alternative systems, servers and/or client devices may be communicatively coupled via any number and/or type(s) of public and/or private networks, and/or may be located and/or implemented at any number and/or type(s) of different geographically locations. Further, any of the methods, apparatus and articles of manufacture described herein could be implemented by or within a clinical records access terminal and/or client device that is communicatively coupled to the example clinical records server 100. Further still, clinical records displays generated by an example clinical history presenter 105 may be presented at the clinical records server 100 and/or at a clinic records access terminal and/or client device communicatively coupled to the server 100. Moreover, the example clinical history presenter 105 may be implemented at any number and/or type(s) of clinical records access terminals and/or client devices communicatively coupled to a clinical records server such as the example clinical records server 100.

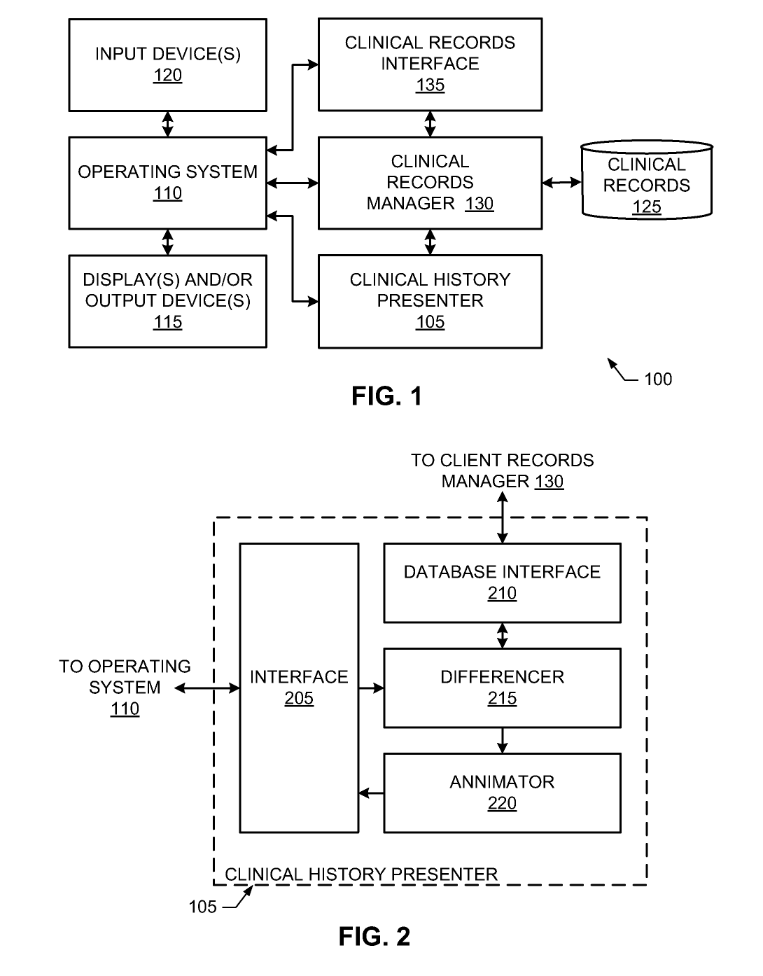

FIG. 1 illustrates the example clinical records server 100. To allow a user (not shown) to interact with the example clinical records server 100, the clinical records server 100 of FIG. 1 includes an operating system 110, any number and/or type(s) of display(s) and/or output device(s) 115, and any number and/or type(s) of input device(s) 120. The example operating system 110 of FIG. 1 enables information (e.g., clinical records, medical records, test results, images, windows, screens, interfaces, dialog boxes, etc.) to be displayed at the display(s) and/or output device(s) 115, and to allow a user to control, configure and/or operate the example clinical records server 100 via the input device(s) 120. The user provides and/or makes inputs and/or selections via the input device(s) 120. Example input devices 120 include, but are not limited to, a keyboard, a touch screen, a trackball and/or a mouse.

To manage patient and/or clinical records 125, the example clinical records server 100 of FIG. 1 includes a clinical records manager 130. The example clinical records manager 130 of FIG. 1 enables users via the operating system 110, the input device(s) 120, and/or the display(s) and/or output device(s) 115 to query and/or search for clinical records in the clinical records database 125. The example clinical records manager 130 also enables users via the operating system 110, the input device(s) 120, the display(s) and/or output device(s) 115 to add, create and/or modify clinical records in the database 125. In some examples, clinical records access terminals and/or client devices can access the clinical records database 125 via a clinical records interface or application programming interface 135 and the clinical records manager 130, and via any number and/or type(s) of private and/or public network(s). Patient and/or clinical records may be stored in the example clinical records database 125 using any number and/or type(s) of data structures, entries, tables and/or records. The example clinical records database 125 may be implemented by any number and/or type(s) of memory(-ies), memory device(s) and/or storage device(s).

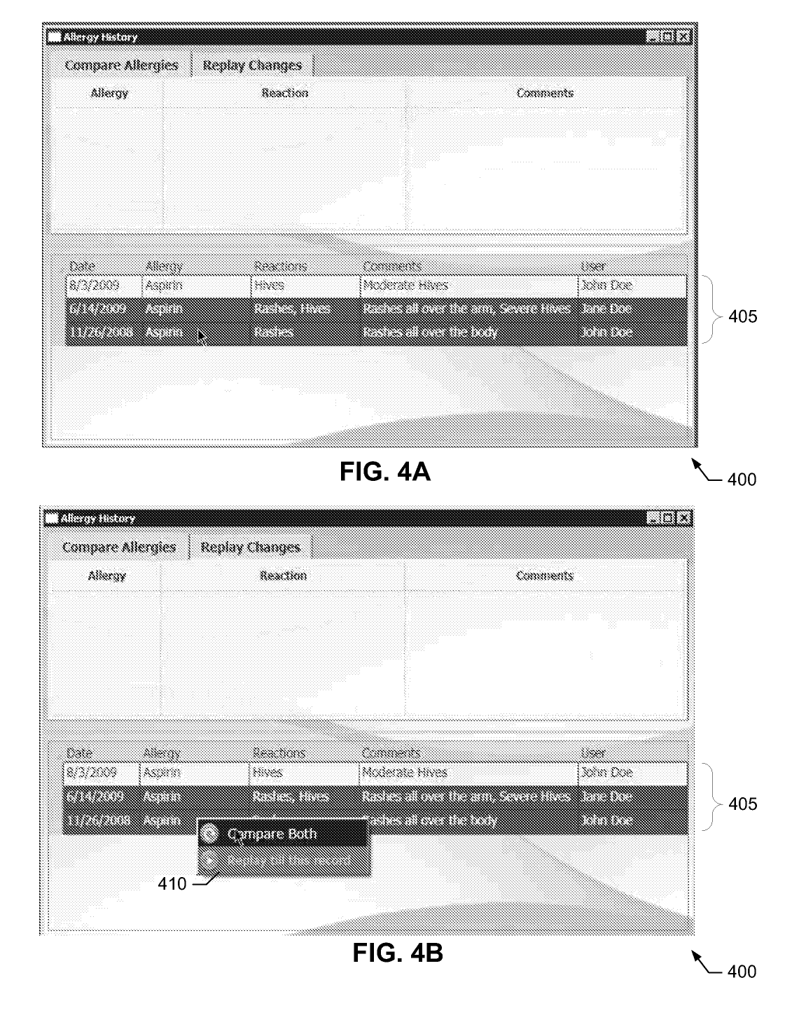

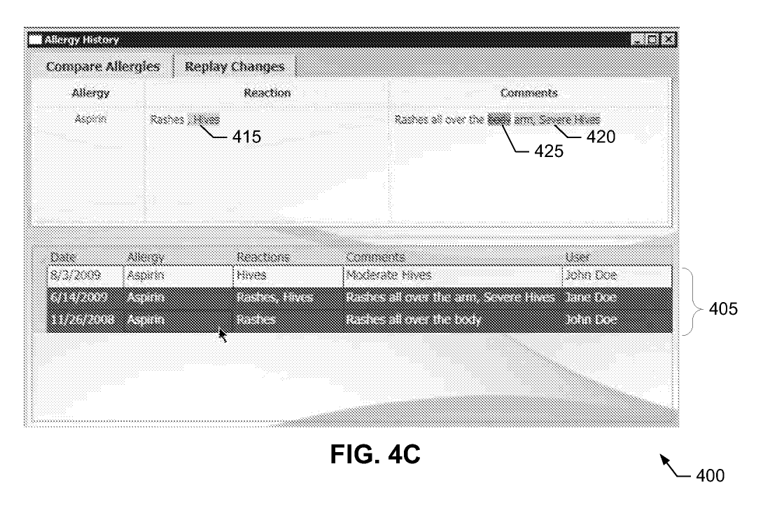

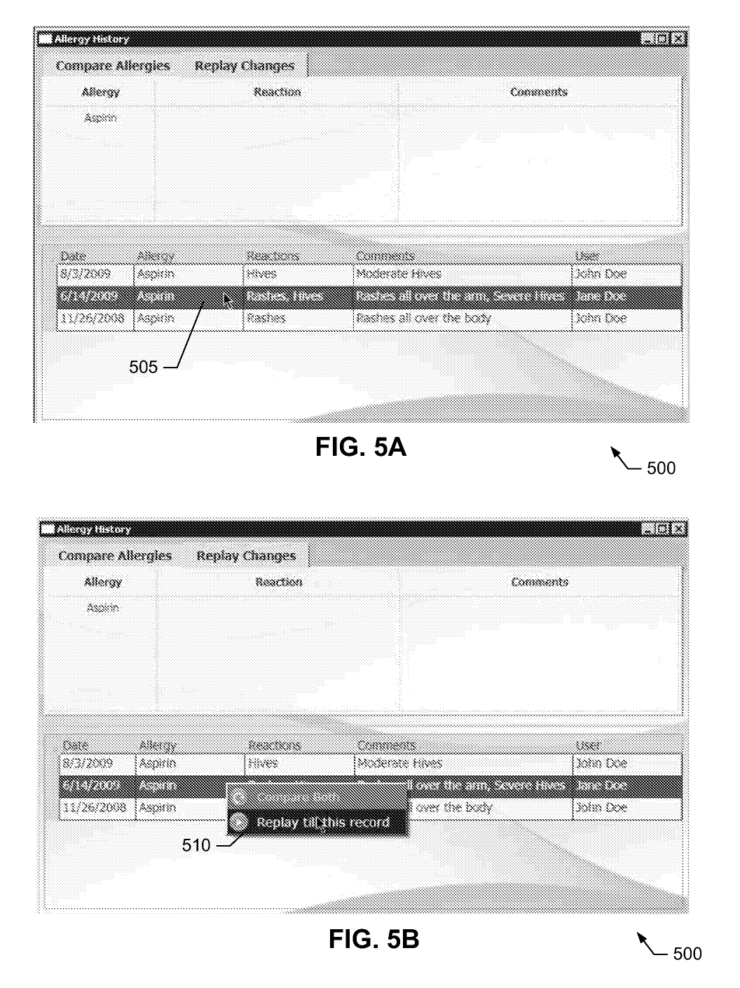

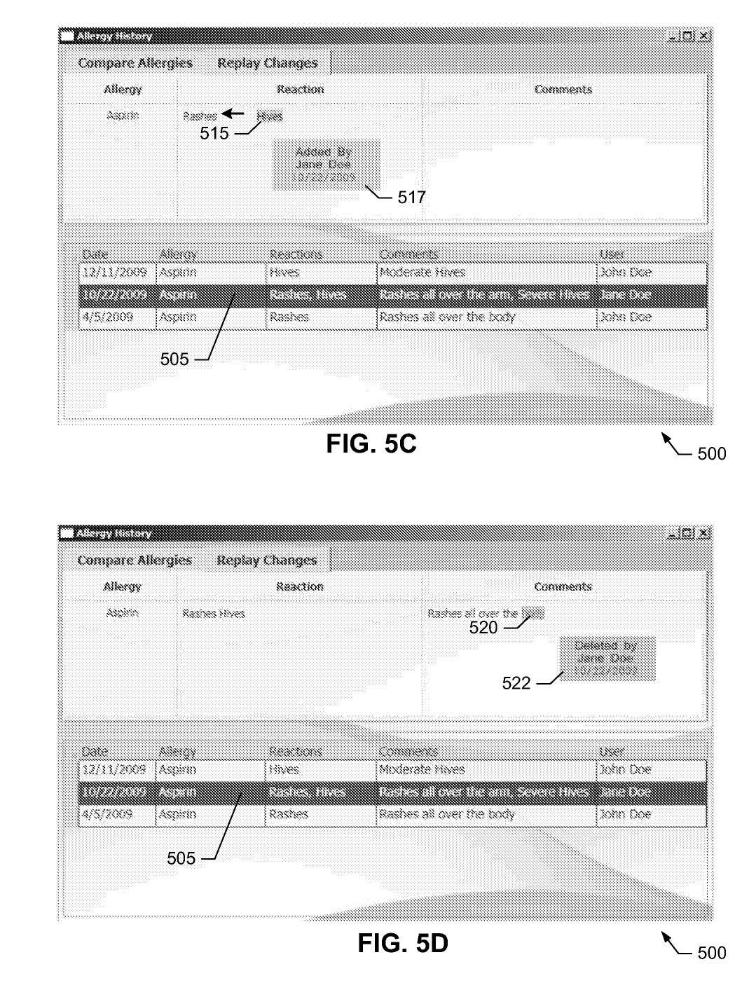

To create, form, generate and/or otherwise present clinical record displays that automatically highlight and/or emphasize changes and/or differences between clinical records, the example clinical record server 100 of FIG. 1 includes the example clinical history presenter 105. The example clinical history presenter 105 of FIG. 1 will be described in conjunction with an example manner of implementing the example clinical history presenter 105 depicted in FIG. 2 and example clinical record displays 400 and 500 depicted in FIGS. 4A-C and 5A-F, respectively.

FIG. 4A depicts an example clinical record display 400 showing three example clinical records 405 containing information relating to a patient's allergy to aspirin. In FIG. 4A two of the example records 405 are highlighted indicating they have been selected via the input device(s) 120 and/or operating system 110 for processing, analysis and/or comparison. In the example clinical record display 400 of FIG. 4B, a user of the example clinical records server 100 activates a pop-up window 410 by, for example, right clicking one of the highlighted records 405, and selects comparison of the highlighted or selected records 405.

In response to the example selection of FIG. 4B, an interface 205 and/or 210 (FIG. 2) of the example clinical history presenter 105 obtains the contents of the selected clinical records. In some examples, the example interface 205 obtains the contents of the selected clinical records from and/or via the operating system 110. Additionally or alternatively, the example operating system 110 provides identifiers of the selected records to the clinical history presenter 105 via the example interface 205 and the example database interface 210 of FIG. 2 obtains the contents of the selected records by querying the example clinical records database 125 via the example clinical records manager 130.

To identify differences between the obtained clinical records, the example clinical history presenter 105 of FIG. 2 includes a differencer 215. Using any number and/or type(s) of method(s), logic, algorithm(s) and/or process(es), the example differencer 215 of FIG. 2 compares the contents (e.g., text, numbers, data, flags, etc.) of the obtained clinical records to automatically identify the differences.

To create, generate and/or form a clinical record display that includes and emphasizes or highlights the identified differences, the example clinical history presenter 105 of FIG. 2 includes an animator 220. Starting with a first of the selected clinical records, the example animator 220 of FIG. 2 forms a clinical record display containing the contents of the first clinical record and containing additional text that may have been present in others of the selected clinical records but absent in the first clinical record. As shown in FIG. 4C, text 415 and 420 that is present in the Jun. 14, 2009 record 405 but absent in the Nov. 26, 2008 record 405 is highlighted using a first color such as green. In some examples, such text may, additionally or alternatively, be underlined. As also shown in FIG. 4C, text 425 that is absent in the Jun. 14, 2009 record 405 but present in the Nov. 26, 2008 record 408 is highlighted using a different color such as red and may, additionally or alternatively, be struck through (e.g., struck through). While example methods of emphasizing or depicting changes between clinical records are described and illustrated herein. Any number and/or type(s) of additional and/or alternative methods may be used to emphasize, present and/or depict changes. For example, other combinations of font style, font color, background color, striking through with other characters (e.g., striking through with the letter x), and/or font style may be used. Further, in some examples, a user of the example clinical record server 100 can customize and/or select how clinical records changes are displayed, emphasized and/or presented. Further still, for animated clinical record displays, the user may configure and/or select the rate at which changes are displayed. Moreover, as discussed below in connection with FIGS. 5C and 5D, information regarding who made the depicted change(s) between clinical records may be displayed.

By automatically identifying and emphasizing or highlighting the differences between the selected records as shown in the illustrated example clinical record display of FIG. 4C, a user of the example clinical record server 100 of FIG. 1 can visually, quickly and/or reliably identify and/or note changes to the patient's medical history that have occurred. The example clinical record display 400 of FIG. 4C can be presented by the example animator 220 of FIG. 2 at one or more of the example display(s) and/or output device(s) 115 via the interface 205 and the operating system 110, and/or may be stored in a data file such an image file for subsequent transmission, retrieval and/or presentation. Example image files are constructed in accordance with the JPEG and GIF file formats. While for ease of discussion, two records 405 were compared in example of FIGS. 4A-4C, the example differencer 215 and the example animator 220 of FIG. 2 can identify, display and/or emphasize any number of differences between any number and/or type(s) of selected clinical records.

As shown in FIGS. 5A-F, differences between clinical records may, additionally or alternatively, be displayed using an animated clinical record display. In the example clinical record display 500 of FIG. 5A, a single clinical record 505 is selected or highlighted. In the example clinical record display 500 of FIG. 5B, a user of the example clinical records server 100 activates a pop-up window 510 by, for example, right clicking the highlighted record 505, and selects a replay, story board, animated display and/or animated presentation of clinical record changes starting with the earliest displayed clinical record up to and including the selected record 505.

As described above, the example differencer 215 of FIG. 2 obtains the contents of the selected clinical record 505 and clinical records that precede it in time via the example interfaces 205 and 210, and automatically identifies the differences between the obtained clinical records. Rather than displaying all of the identified changes simultaneously as in the illustrated example of FIG. 4C, the example animator 220 of FIG. 2 presents the identified changes in an animated clinical record display 500, as shown in FIGS. 5C-F. The illustrated examples of FIGS. 5C-F depict example snapshots of an example animated clinical record display 500 taken over time. The example animated clinical record display 500 of FIGS. 5C-5F may be displayed may be presented at one or more of the example display(s) and/or output device(s) 115 via the interface 205 and the operating system 110, and/or may be stored in a data file such a multimedia or video file for subsequent transmission, retrieval and/or presentation. An example video file is constructed in accordance with the Windows Media Video (WMV) file format. During a first time interval or period depicted in FIG. 5C, text 515 that is present in the Jun. 14, 2009 record but absent in the Nov. 26, 2008 record is highlighted in a color such as green and is moved from right to left to signify that the text 515 that was added to the later Jun. 14, 2009 record 505. As shown in FIG. 5C, information 517 regarding who added the text 515 and/or when the text 515 was added may be displayed.

When the example text 515 has been moved into place and highlighting of the text 515 disabled, as shown in FIG. 5D, text 520 that is present in the example Nov. 26, 2008 record but absent in the example Jun. 14, 2009 record 505 is highlighted in a different color such as red. As shown in FIG. 5D, information 522 regarding who made the change 520 and/or when the change 520 was made may be displayed. After the text 520 has been highlighted for a period of time, the example animator 220 removes the text 520, as shown in FIG. 5E, and begins moving additional highlighted text 525 in from the right to represent text present in the Jun. 14, 2009 record 505 that was also not present in the Nov. 26, 2008 record. When the animated display 500 has completed and/or stopped, the selected record 505 is statically presented as shown in FIG. 5F.

While changes were depicting with moving text in the example of FIGS. 5C-5F, changes between clinical records may be depicted, highlighted and/or emphasized using any number and/or type(s) of other methods. Other example methods of emphasizing changes include, but are not limited to, zooming text (e.g., text that gets smaller or bigger), appearing text (e.g., slowly and/or gradually appears), disappearing text (e.g., slowly and/or gradually disappearing or fading), rotating text, bouncing text (e.g., text moving up and down), vibrating text (e.g., text moving left and right), swirling text and/or any other method(s) of moving or animating text.

While for ease of discussion, only one clinical record preceded the selected record 505 in example of FIGS. 5A-5F, the example differencer 215 and the example animator 220 of FIG. 2 can generate an animated clinical display depicting changes that occurred over any number and/or type(s) of clinical records. Consider an example sequence of selected clinical records R1, R2, R3 and R4, where R1 is the selected base clinical record 505. An example animated clinical record display depicts in sequence the changes from R4 to R3, the changes from R3 to R2, and the changes from R2 to R1. Another example clinical record display depicts in sequence the changes from R2 to R1, from R3 to R1 and from R4 to R1. Further, while the example animations shown in FIGS. 5A-5F were formed based on the differences between clinical records, an animated clinical display may, additionally or alternatively, display an animated depiction of how the changes may were made.

While in the illustrated examples of FIGS. 4A-4C and FIGS. 5A-5F clinical records were selected from clinical records relating to an aspirin allergy, any number and/or type(s) of additional and/or alternative methods may be used to identify a set of clinical records between which differences and/or changes are depicted. For example, a set of clinical records that were created, modified and/or deleted by a particular user (e.g., a medical professional) may be identified for comparison. Further, changes made by the single user to different versions of a same clinical record may be displayed.

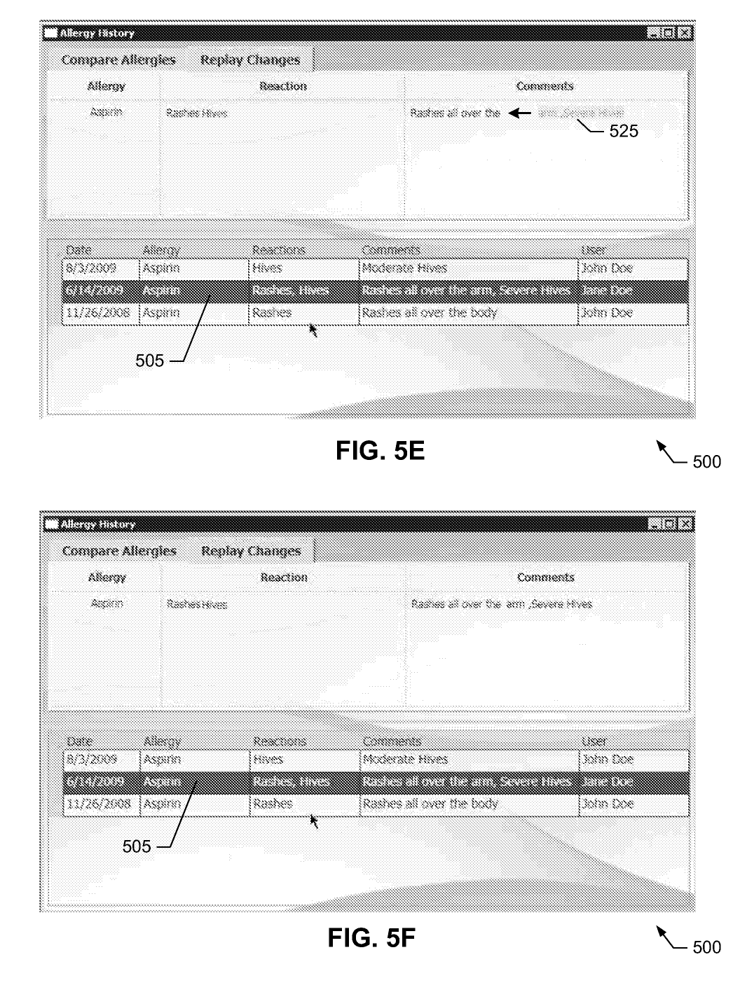

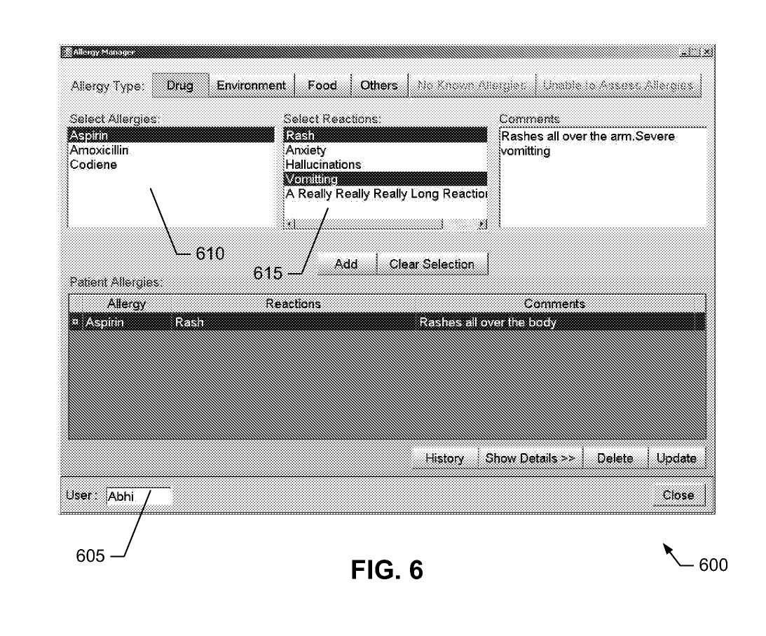

Further still, while the example clinical record displays of FIGS. 4C and 5C-5F depict clinical records and changes between clinical records, other example clinical record displays depict how identified changes were made or entered. For example, while users add, modify and/or delete clinical records their actions (e.g., keystrokes, mouse movements, menu activations, etc.) could be recorded. Such actions could be presented or replayed statically or dynamically to depict how the differences between clinical records arose. An example snapshot 600 of such a clinical record display is shown in FIG. 6. The example snapshot 600 of FIG. 6 includes a field 605 identifying an example user making the changes, a field 610 where aspirin allergies are selected and a field 615 where one or more allergic reactions to aspirin may be selected. The example snapshot 600 of FIG. 6 may be animated by replaying recording mouse movements showing that the example user 605 selected aspirin in the example field 610 and then selected vomiting in the example field 615. An animated clinical record display may include more than one snapshot such as the example snapshot 600 of FIG. 6.

While example manners of implementing the example clinical records server 100 and the clinical history presenter 105 are illustrated in FIGS. 1 and 2, respectively, one or more of the interfaces, data structures, elements, processes and/or devices illustrated in FIGS. 1 and/or 2 may be combined, divided, re-arranged, omitted, eliminated and/or implemented in any other way. For example, the example clinical history presenter 105, the example operating system 110, the example display(s) and/or output device(s) 115, the example input device(s) 120, the example clinical records database 125, the example clinical records manager 130, the example clinical records interface 135, the example interfaces 205 and 210, the example differencer 215, the example animator 220 and/or, more generally, the example clinical records server 100 of FIGS. 1 and 2 may be implemented by hardware, software, firmware and/or any combination of hardware, software and/or firmware. Thus, for example, any of the example clinical history presenter 105, the example operating system 110, the example display(s) and/or output device(s) 115, the example input device(s) 120, the example clinical records database 125, the example clinical records manager 130, the example clinical records interface 135, the example interfaces 205 and 210, the example differencer 215, the example animator 220 and/or, more generally, the example clinical records server 100 may be implemented by one or more circuit(s), programmable processor(s), application specific integrated circuit(s) (ASIC(s)), programmable logic device(s) (PLD(s)) and/or field programmable logic device(s) (FPLD(s)), etc. When any apparatus claim of any patent resulting from this provisional application is read to cover a purely software and/or firmware implementation, at least one of the example clinical history presenter 105, the example operating system 110, the example display(s) and/or output device(s) 115, the example input device(s) 120, the example clinical records database 125, the example clinical records manager 130, the example clinical records interface 135, the example interfaces 205 and 210, the example differencer 215, the example animator 220 and/or, more generally, the example clinical records server 100 are hereby expressly defined to include a tangible computer-readable medium such as a memory, a digital versatile disc (DVD), a compact disc (CD), etc. storing the firmware and/or software. Further still, the example clinical records server 100 and/or the example clinical history presenter 105 may include interfaces, data structures, elements, processes and/or devices instead of, or in addition to, those illustrated in FIGS. 1 and 2 and/or may include more than one of any or all of the illustrated interfaces, data structures, elements, processes and/or devices.

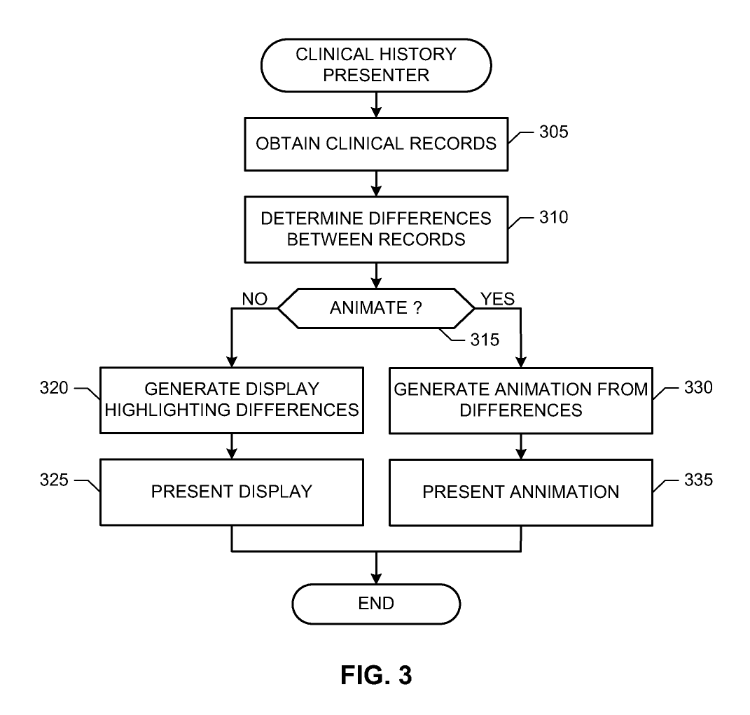

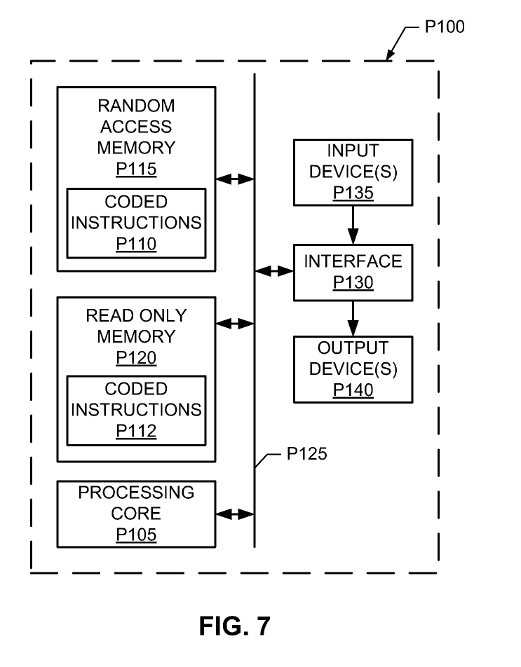

FIG. 3 illustrates an example process that may be carried out to implement the example clinical history presenter 105 and/or, more generally, the example clinical records server 100 of FIGS. 1 and 2. The example process of FIG. 3 may be carried out by a processor, a controller and/or any other suitable processing device. For example, the example process of FIG. 3 may be embodied in coded instructions stored on a tangible computer-readable medium such as a flash memory, a CD, a DVD, a floppy disk, a read-only memory (ROM), a random-access memory (RAM), a programmable ROM (PROM), an electronically-programmable ROM (EPROM), and/or an electronically-erasable PROM (EEPROM), an optical storage disk, an optical storage device, magnetic storage disk, a magnetic storage device, and/or any other medium which can be used to carry or store program code and/or instructions in the form of computer-executable instructions or data structures, and which can be accessed by a processor, a general purpose or special purpose computer or other machine with a processor (e.g., the example processor platform P100 discussed below in connection with FIG. 7). Combinations of the above are also included within the scope of computer-readable media. Computer-executable instructions comprise, for example, instructions and data that cause a processor, a general purpose computer, special purpose computer, or a special purpose processing machine to perform one or more particular processes. Alternatively, some or all of the example process of FIG. 3 may be implemented using any combination(s) of ASIC(s), PLD(s), FPLD(s), discrete logic, hardware, firmware, etc. Also, some or all of the example process of FIG. 3 may be implemented manually or as any combination of any of the foregoing techniques, for example, any combination of firmware, software, discrete logic and/or hardware. Further, many other methods of implementing the example operations of FIG. 3 may be employed. For example, the order of execution of the blocks may be changed, and/or one or more of the blocks described may be changed, eliminated, sub-divided, or combined. Additionally, any or all of the example process of FIG. 3 may be carried out sequentially and/or carried out in parallel by, for example, separate processing threads, processors, devices, discrete logic, circuits, etc.

The example process of FIG. 3 begins with the example clinical history presenter 105 obtaining the contents of selected clinical records (block 305). The example differencer 215 of FIG. 2 automatically determines the differences between the selected clinical records (block 310). If the clinical record display is to not be animated (block 315), the example animator 220 presents a static clinical record display, such as that discussed above in connection with FIG. 4C, that emphasizes or highlights the differences identified by the example differencer 215 (block 320). The static clinical record display is presented, for example, via the example display(s) and/or output device(s) 115 (block 325). Control then exits from the example process of FIG. 3.

Returning to block 315, if the clinical record display is to be animated (block 315), the example animator 220 generates, forms and/or creates an animation such as that illustrated above in connection with FIGS. 5C-F (block 330). The animated clinical record display is presented, for example, via the example display(s) and/or output device(s) 115 (block 335). Control then exits from the example process of FIG. 3.

FIG. 7 is a schematic diagram of an example processor platform P100 that may be used and/or programmed to implement the example clinical records server 100 and/or the example clinical history presenter 105 of FIGS. 1 and 2. For example, the processor platform P100 can be implemented by one or more general-purpose processors, processor cores, microcontrollers, etc.

The example processor platform P100 of FIG. 7 includes at least one programmable processing core P105. The example processing core P105 executes coded and/or machine-accessible instructions P110 and/or P112 stored in the memory space of the processing core P105 (e.g., within a RAM P115 and/or a ROM P120). The example processing core P105 may be any type of processing unit, such as a processor core, a processor and/or a microcontroller. The processing core P105 may execute, among other things, the example process of FIG. 3, and/or to implement any of the example methods, apparatus and articles of manufacture disclosed herein.

The example processing core P105 is in communication with the memory (including the ROM P120 and/or the RAM P115) via a bus P125. The RAM P115 may be implemented by dynamic random-access memory (DRAM), synchronous dynamic random-access memory (SDRAM), and/or any other type of RAM device, and the ROM P120 may be implemented by flash memory(-ies) and/or any other type of memory(-ies) and/or memory device(s). Access to the memories P115 and P120 may be controlled by a memory controller (not shown). The example memories P115 and/or P120 may be used to implement the example clinical records database 125.

The processor platform P100 also includes an interface circuit P130. The interface circuit P130 may be implemented by any type of interface standard, such as an external memory interface, serial port, general-purpose input/output, etc. One or more input devices P135 and one or more output devices P140 are connected to the interface circuit P130. The input devices P135 and/or output devices P140 may be used to, for example, implement the example display(s) and/or output device(s) 115, the example input device(s) 120 and/or the example interfaces 205 and 210 of FIGS. 1 and 2.

Generally, computer-executable instructions include routines, programs, objects, components, data structures, etc., that perform particular tasks or implement particular abstract data types. Computer-executable instructions, associated data structures, and program modules represent examples of program code for executing the processes to implement the example methods and systems disclosed herein. The particular sequence of such executable instructions and/or associated data structures represent examples of corresponding acts for implementing the examples described herein.

The example methods and apparatus described herein may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Such network computing environments may encompass many types of computer system configurations, including personal computers, hand-held devices, multi-processor systems, microprocessor-based or programmable consumer electronics, network PCs, minicomputers, mainframe computers, and the like. The example methods and apparatus described herein may, additionally or alternatively, be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method comprising:
identifying a difference between first and second clinical records of a patient;
forming an animated clinical record display including the first clinical record and an animated depiction of the identified difference; and
presenting the animated clinical record display at an output device.

2. A method as defined in claim 1, further comprising:
receiving user selections identifying the first and second clinical records; and
querying a clinical records database to obtain the first and second clinical records.

3. A method as defined in claim 1, wherein the identified difference comprises text present in the first clinical record and absent in the second clinical record, and the animated depiction of the identified difference comprises at least one of moving, rotating, bouncing, rotating, swirling, highlighting, changing the color of, or underlining the text.

4. A method as defined in claim 1, wherein the identified difference comprises first text present in the first clinical record and absent in the second clinical record, and forming the animated clinical record display comprises:
moving second text in the presented first clinical record to form a modified presented first clinical record; and
inserting the first text in the modified presented first clinical record.

5. A method as defined in claim 1, wherein the identified difference comprises text present in the first clinical record and absent in the second clinical record, and forming the animated clinical record display comprises:
adding the text to the presented first clinical record to form a modified presented first clinical record; and
emphasizing the added text in the modified presented first clinical record using at least of a different font, a different font style, a different background color, a different font color, a different font style, or underlining.

6. A method as defined in claim 1, wherein the identified difference comprises text absent in the first clinical record and present in the second clinical record, and forming the animated clinical record display comprises:
inserting the text to the presented first clinical record; and
emphasizing the inserted text using at least of a different font, a different font style, a different font color, a different background color, a different font style, or striking through.

7. A method as defined in claim 1, wherein the identified difference comprises first text absent in the first clinical record and present in the second clinical record, and forming the animated clinical record display comprises:
moving second text in the presented first clinical record to form a modified presented first clinical record;
inserting the first text in the modified presented first clinical record; and
emphasizing the inserted text using at least of a different font, a different font style, a different font color, a different background color, a different font style, or striking through.

8. A method as defined in claim 7, wherein inserting the first text comprises at least one of moving, vibrating, rotating, bouncing, or swirling the first text.

9. A method as defined in claim 1, wherein the identified difference comprises text absent in the first clinical record and present in the second clinical record, and forming the animated clinical record display comprises:
adding the text to the presented first clinical record; and
emphasizing the added text in the modified presented first clinical record using at least of a different font, a different font style, a different font color, a different background color, a different font style, or striking through.

10. A method as defined in claim 1, wherein the animated clinical record display comprises presenting at least one of a record keystroke, a mouse movement, or a selection.

11. An apparatus comprising:
a differencer to identify a difference between first and second clinical records, the first and second clinical records associated with a same patient;
an animator to form clinical record display including the first clinical record and an animated emphasized representation of the identified difference; and
an output device to present the animated clinical record display.

12. An apparatus as defined in claim 11, further comprising:
an input device to receive selections representative of the first and second clinical records; and
an interface to query a clinical records database to obtain the first and second clinical records.

13. An apparatus as defined in claim 11, wherein the identified difference comprises text present in the first clinical record and absent in the second clinical record, and the emphasized representation of the identified difference comprises at least one of a different font, a different font style, a different font color, a different background color, a different font style, a moving, or an underlining of the text.

14. An apparatus as defined in claim 11, wherein the identified difference comprises text absent in the first clinical record and present in the second clinical record, and the emphasized representation of the identified difference comprises at least one of a different font, a different font style, a different font color, a different background color, a different font style, a moving, or a striking through of the text.

15. An apparatus as defined in claim 11, wherein the identified difference comprises first text present in the first clinical record and absent in the second clinical record, and the clinical record display comprises:
moving second text in the first clinical record to form a gap; and
moving the first text into the gap.

16. An apparatus as defined in claim 15 wherein moving the first text comprises at least one of moving, vibrating, rotating, bouncing, or swirling the first text.

17. An article of manufacture storing machine-readable instructions that, when executed, cause a machine to:
identify a difference between first and second clinical records of a patient;
present the first clinical record at an output device; and
modify the presented first clinical record to emphasize the identified difference.

18. An article of manufacture as defined in claim 17, wherein the machine-readable instructions, when executed, cause the machine to:
receive user selections identifying the first and second clinical records; and
query a clinical records database to obtain the first and second clinical records.

19. An article of manufacture as defined in claim 17, wherein the identified difference comprises first text present in the first clinical record and absent in the second clinical record, and wherein the machine-readable instructions, when executed, cause the machine to modify the presented first clinical record by presenting an animated display including:
moving second text in the presented first clinical record to form a modified presented first clinical record; and
inserting the first text in the modified presented first clinical record.

20. An article of manufacture as defined in claim 19, wherein the machine-readable instructions, when executed, cause the machine to insert the first text by at least one of moving, vibrating, rotating, bouncing, or swirling the first text.

21-25. (canceled)
